(19) United States
(12) Patent Application Publication
(10) Pub. No.: US 2004/0233466 A1
(43) Pub. Date: Nov. 25, 2004

(54) Electronic device for transfer of image data

(76) Inventors: Hidenori Shindoh, Tokyo (JP); Osamu Kizaki, Saitama (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/799,707

(22) Filed: Mar. 15, 2004

(30) Foreign Application Priority Data
Mar. 17, 2003 (JP) 2003-072629
Feb. 19, 2004 (JP) 2004-042783

(51) Int. Cl. G06F 15/00; G06K 15/00

(52) U.S. Cl. 358/1.13; 358/1.9

(57) ABSTRACT

An electronic device, which receives image data, and converts the image data for outputting therefrom, includes a plurality of conversion units configured to convert the image data, a control unit configured to control the conversion units, an image data transfer unit configured to transfer the image data between the control unit and at least one of the conversion units, and a clock unit configured to provide synchronization between the control unit and at least one of the conversion units for transfer of the image data.

### BACKGROUND OF THE INVENTION

1. Field of the Invention

The present invention generally relates to image data processing, and particularly relates to an electronic device for converting image data, an image forming apparatus having such an electronic device incorporated therein, and a method of converting image data.

2. Description of the Related Art

In recent years, an image forming apparatus that combines a plurality of machine-specific functions such as those of a facsimile machine, a printer, a copier, a scanner, etc., in one device has become widely popular. This image forming apparatus is provided with a display unit, a print unit, an imaging unit, etc., in one device, and is also provided with four applications corresponding to a facsimile machine, a printer, a copier, and a scanner, respectively. Switching of the applications provides for the image forming apparatus to perform any desired functions of a printer, a copier, a facsimile machine, and a scanner.

Such an image forming apparatus converts image data in order to ensure proper handling of different types of image data, and attends to compression/decompression of image data in order to save hardware resources of the image forming apparatus. In the following, a description will be given of a related art relevant to such conversion (including compression/decompression).

FIG. 20 is an illustrative drawing showing the conversion of image data laid out in a RAM by conversion apparatuses A, B, and C connected to an image forming apparatus. The conversion apparatuses A, B, and C obtain image data through an ASIC (application specific integrated circuit), and convert the obtained image data.

If conversion is carried out by the conversion apparatuses A, B, and C in the order named, exchange of image data between the respective conversion apparatuses and the RAM is performed as shown in FIG. 20. Since the RAM and the conversion apparatuses are connected through a bus to which other apparatuses are also connected for shared use of the bus, the conversion of image data ends up exclusively occupying the shared bus. Further, each time a conversion apparatus finishes processing, an upper-order apparatus (i.e., the image forming apparatus) needs to perform control cooperation. This imposes the large load on the upper-order apparatus, and makes it difficult to establish synchronization.

Accordingly, there is a need for an electronic device that does not exclusively occupy a shared bus and does not impose the load on an upper-order apparatus. There are also a need for a need for an image forming apparatus in which such an electronic device is provided, and a need for a method of converting image data.

### SUMMARY OF THE INVENTION

It is a general object of the present invention to provide an electronic device, an image forming apparatus, and a method of converting image data that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by an electronic device, an image forming apparatus, and a method of converting image data particularly pointed out in the specification in such full, clear, concise, and exact terms as to enable a person having ordinary skill in the art to practice the invention.

To achieve these and other advantages in accordance with the purpose of the invention, an electronic device, which receives image data, and converts the image data for outputting therefrom, includes a plurality of conversion units configured to convert the image data, a control unit configured to control said conversion units, an image data transfer unit configured to transfer the image data between said control unit and at least one of said conversion units, and a clock unit configured to provide synchronization between said control unit and at least one of said conversion units for transfer of the image data.

According to another aspect of the invention, said control unit supplies to one of said conversion units a signal indicative of a start of transfer of the image data when transferring the image data to the one of said conversion units.

According to another aspect of the invention, said control unit supplies to one of said conversion units a signal indicating that the image data being transferred is a sub-scan portion when the sub-scan portion of the image data is being transferred to the one of said conversion units.

According to another aspect of the invention, said control unit supplies to one of said conversion units a signal indicating that the image data being transferred is a main-scan portion when the main-scan portion of the image data is being transferred to the one of said conversion units.

According to another aspect of the invention, one of said conversion units supplies to said control unit a signal indicative of a start of transfer of the converted image data when transferring the converted image data to said control unit.

According to another aspect of the invention, one of said conversion units supplies to said control unit a signal indicating that the image data being transferred is a sub-scan portion when the sub-scan portion of the converted image data is being transferred to said control unit.

According to another aspect of the invention, one of said conversion units supplies to said control unit a signal indicating that the image data being transferred is a main-scan portion when the main-scan portion of the converted image data is being transferred to said control unit.

According to another aspect of the invention, at least one of said conversion units further includes an interruption unit configured to output an interruption signal to said control unit.

According to another aspect of the invention, said interruption unit outputs the interruption signal in response to a completion of conversion of image data that is equal to a predetermined amount.

According to another aspect of the invention, said interruption unit outputs the interruption signal in response to a completion of conversion of image data that is equal in amount to one page of a print sheet.

According to another aspect of the invention, said interruption unit outputs the interruption signal in response to an error occurring during the conversion of the image data.

According to another aspect of the invention, said control unit makes one of said conversion units convert the image data according to a request indicative of specifics of conversion that is applied to the image data.

According to another aspect of the invention, said control unit selects one of said conversion units according to the request so as to make the selected one of said conversion units convert the image data.

According to another aspect of the invention, the request specifies a format of the image data prior to conversion and a format of the converted image data.

According to another aspect of the invention, the image data is transferred at a constant rate between said control unit and at least one of said conversion units.

According to another aspect of the invention, each of said conversion units is a chip.

According to another aspect of the invention, the electronic device as described above is implemented on a printed circuit board that is connectable to an upper-order apparatus.

According to another aspect of the invention, the image data is received from the upper-order apparatus, and the converted image data is output to the upper-order apparatus.

According to another aspect of the invention, said control unit is also configured to convert the image data.

According to another aspect of the invention, an image forming apparatus includes hardware resources configured to form images, a memory having a program stored therein for causing said hardware resources to form the images, and an electronic device configured to receive image data and convert the image data for outputting therefrom. The electronic device includes a plurality of conversion units configured to convert the image data, a control unit configured to control said conversion units, an image data transfer unit configured to transfer the image data between said control unit and at least one of said conversion units, and a clock unit configured to provide synchronization between said control unit and at least one of said conversion units for transfer of the image data.

According to another aspect of the invention, the image forming apparatus as described above further includes a conversion request generating unit which generates a conversion request, wherein said electronic device converts the image data in response to the conversion request.

According to another aspect of the invention, the image forming apparatus as described above further includes a conversion-type specifying unit which generates information about a format of the image data prior to conversion and a format of the image data after the conversion, said information being supplied to said conversion request generating unit.

According to another aspect of the invention, said conversion request generating unit generates the conversion request responsive to the information supplied from said conversion-type specifying unit.

According to another aspect of the invention, the image forming apparatus as described above further includes a memory-area allocating unit which allocates a memory area in which the image data to be converted by said electronic device and the converted image data are stored.

According to another aspect of the invention, a method of converting image data by use of a plurality of conversion units configured to convert the image data and a control unit configured to control the conversion units includes the steps of notifying the control unit of a type of conversion that is to be performed with respect to the image data, selecting, by the control unit, one of the conversion units in response to the notified type of conversion, supplying, from the control unit to the selected one of the conversion units, a clock signal that provides synchronization for transfer of the image data, supplying, from the control unit to the selected one of the conversion units, a signal indicative of a start of transfer of the image data, and transferring the image data from the control unit to the selected one of the conversion units.

According to another aspect of the invention, the method as described above further includes the steps of transmitting, from the selected one of the conversion units to the control unit, a clock signal that provides synchronization for transfer of converted image data, and transferring the converted image data from the selected one of the conversion units to the control unit.

According to another aspect of the invention, a method of converting image data by use of a plurality of conversion units configured to convert the image data, a control unit configured to control the conversion units, and a conversion request generating unit configured to request conversion, includes the steps of generating, by the conversion request generating unit, information about the type of conversion that is to be performed with respect to the image data, instructing, by the conversion request generating unit, the control unit to perform the conversion based on the information, selecting, by the control unit, one of the conversion units in response to the notified type of conversion, supplying, from the control unit to the selected one of the conversion units, a clock signal that provides synchronization for transfer of the image data, supplying, from the control unit to the selected one of the conversion units, a signal indicative of a start of transfer of the image data, and transferring the image data from the control unit to the selected one of the conversion units.

According to another aspect of the invention, the method as described above further includes a step of notifying, by the control unit, the conversion request generating unit of a completion of the conversion of the image data.

The invention as described above provides an electronic device that does not exclusively occupy a shared bus and does not impose the load on an upper-order apparatus, an image forming apparatus in which such an electronic device is provided, and a method of converting image data.

Other objects and further features of the present invention will be apparent from the following detailed description when read in conjunction with the accompanying drawings.

### BRIEF DESCRIPTION OF THE DRAWINGS

FIG. 1 is a block diagram showing an embodiment of a multifunction peripheral serving as an image forming apparatus according to the invention;

FIG. 2 is a block diagram showing a hardware construction of an embodiment of the multifunction peripheral;

FIG. 3 is an illustrative drawing showing the construction of an MLB;

FIG. 4 is a diagram for explaining the conversion function of an MLC, a Ri, and a RJ2K;

FIG. 5 is a diagram for explaining the flow of image data when the image data is converted by the MLB;

FIG. 6 is a sequence chart showing signals exchanged between the MLC and the Ri;

FIG. 7 is a sequence chart showing the exchange of signals between the MLC an the RJ2K;

FIG. 8 is a flowchart showing a procedure performed by an IMH and an MEU;

FIG. 9 is an illustrative drawing for explaining a pass code;

FIG. 10 is a pass code table showing only a portion relating to grayscale among various image types;

FIG. 11 is an illustrative drawing for explaining the registers of the MLB;

FIG. 12 is an illustrative drawing for explaining a case in which the Ri performs conversion;

FIG. 13 is an illustrative drawing showing the flow of image data of the process of FIG. 12 inside the MLB shown in FIG. 5;

FIG. 14 is an illustrative drawing showing a case in which the MLC as well as the Ri attends to conversion;

FIG. 15 is an illustrative drawing showing the flow of image data of the process of FIG. 14 inside the MLB;

FIG. 16 is an illustrative drawing for explaining a process by which the RJ2K attends to conversion;

FIG. 17 is an illustrative drawing showing a case in which conversion is performed by the RJ2K in addition to the Ri and the MLC;

FIG. 18 is an illustrative drawing for explaining the flow of image data of the process of FIG. 17 inside the MLB;

FIG. 19 is an illustrative drawing showing the flow of image data between a memory and an electronic device according to the invention; and

FIG. 20 is an illustrative drawing showing the conversion of image data laid out in a RAM by conversion apparatuses A, B, and C connected to an image forming apparatus.

### DESCRIPTION OF THE PREFERRED EMBODIMENTS

In the following, embodiments of the present invention will be described with reference to the accompanying drawings.

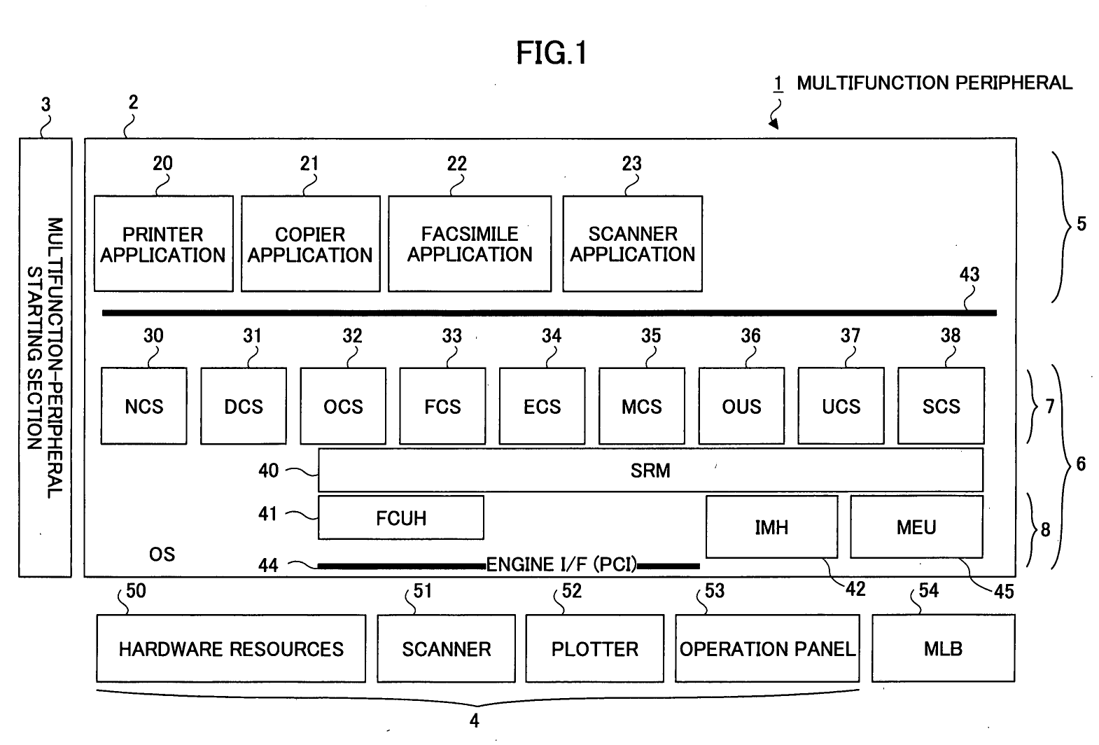

FIG. 1 is a block diagram showing an embodiment of a multifunction peripheral 1 serving as an image forming apparatus according to the invention. The multifunction peripheral 1 includes a program set 2, a multifunction-peripheral starting section 3, and hardware resources 4.

The multifunction-peripheral starting section 3 operates upon the power-on of the multifunction peripheral 1 first, and starts an application layer 5 and a controller 6. For example, the multifunction-peripheral starting section 3 reads programs for the application layer 5 and the controller 6 from a hard disk drive (HDD) or the like, and transfers these programs to respective memory areas for execution. The hardware resources 4 include a scanner 51, a plotter 52, an operation panel 53, an MLB (media link board) 54, and hardware resources 50, which may include a scanner, a facsimile, and the like.

The program set 2 includes the application layer 5 and the controller 6, which are executed on an operating system (hereinafter referred to as an OS) such as UNIX (registered trademark). The application layer 5 includes programs for user-service-specific processes relating to image formation such as a printer, a copier, a facsimile, a scanner, etc.

The application layer 5 includes a printer application 20 used for a printer, a copier application 21 used for a copier, a facsimile application 22 used for a facsimile, and a scanner application 23 used for a scanner.

The controller 6 includes a control service layer 7 which interprets a processing request from the application layer 5 to generate a request for acquiring the hardware resources 4, a system resource manager (SRM) 40 which manages one or more hardware resources 4 to arbitrate acquisition requests from the control service layer 7, and a handler layer 8 which manages the hardware resources 4 in response to the acquisition request from the SRM 40.

The control service layer 7 is configured to include one or more service modules such as a network control service (NCS) 30, a delivery control service (DCS) 31, an operation panel control service (OCS) 32, a fax control service (FCS) 33, an engine control service (ECS) 34, a memory control service (MCS) 35, an on-demand update service (OUS) 36, a user information control service (UCS) 37, and a system control service (SCS) 38.

The controller 6 is configured to include API 43 through a preset function, which makes it possible to receive a processing request from the application layer 5. The OS executes processes in parallel with respect to the software of the application layer 5 and the software of the controller 6.

The process of the NCS 30 provides services which are used by applications that need network I/O. This process serves as an intermediary to distribute data to each application as the data is received through respective protocols from networks and to transmit data to the networks as the data is received from each application.

For example, the NCS 30 controls data communication with network apparatus connected through the networks by HTTP (HyperText Transfer Protocol) by use of the httpd (HyperText Transfer Protocol Daemon).

The process of the DCS 31 controls distribution of accumulated documents and the like. The process of the OCS 32 controls an operation unit, which is used as an interface for communication between a service maintenance person or a user and a control unit. The process of the FCS 33 provides API for performing fax transmission and reception through the PSTN or ISDN network for the application layer 5, the registration/referencing of various fax data stored in backup memory, fax scanning, received fax printing, etc.

The process of the ECS 34 controls engine units such as the scanner 51, the plotter 52, and the hardware resources 50. The process of the MCS 35 performs memory control such as the acquisition and release of memory and the use of HDD, etc. The OUS 36 downloads a program in response to a notice from the network, and lays out the program in memory. The process of the UCS 37 manages user information.

The process of the SCS 38 attends to application management, operation-panel control, system screen display, LED display, hardware resource management, interruption application control, etc.

The process of the SRM 40 together with the SCS 38 attend to system control and the management of the hardware resources 4. For example, the process of the SRM 40 arbitrates in response to acquisition requests from the higher-order layers that are in need of using the hardware resources 4 such as the scanner 51 and the plotter 52, thereby performing execution control.

Specifically, the process of the SRM 40 checks whether the hardware resources 4 requested for acquisition are available. If they are available, the process of the SRM 40 notifies the higher-order layer that the hardware resources 4 requested for acquisition are available. Moreover, the process of the SRM 40 attends to scheduling for use of the hardware resources 4 in response to the acquisition requests from the higher-order layers, and carries out what is requested, i.e., paper feeding and imaging by the printer engine, memory allocation, file generation, etc.

Moreover, the handler layer 8 includes a fax control unit handler (FCUH) 41 that controls and manages a fax control unit (FCU), which will be described later. The handler layer 8 further includes an image memory handler (IMH) 42, which manages the allocation of memory areas to processes and to manage the memory areas assigned to the processes, and also includes an MEU 45 for requesting the MLB 54 to convert image data. The SRM 40 and the FCUH 41 issue a processing request to the hardware resources 4 by use of an engine I/F 44, which enables transmission of the processing request to the hardware resources 4 by use of a predefined function. The MLB 54 serves as an electronic device, the MEU 45 as a conversion request generating unit, and the IMH 42 as a conversion-type specifying unit and a memory-area allocating unit.

In this manner, the multifunction peripheral 1 uses the controller 6 to achieve central processing of various processes required by each application. In the following, the hardware construction of the multifunction peripheral 1 will be described.

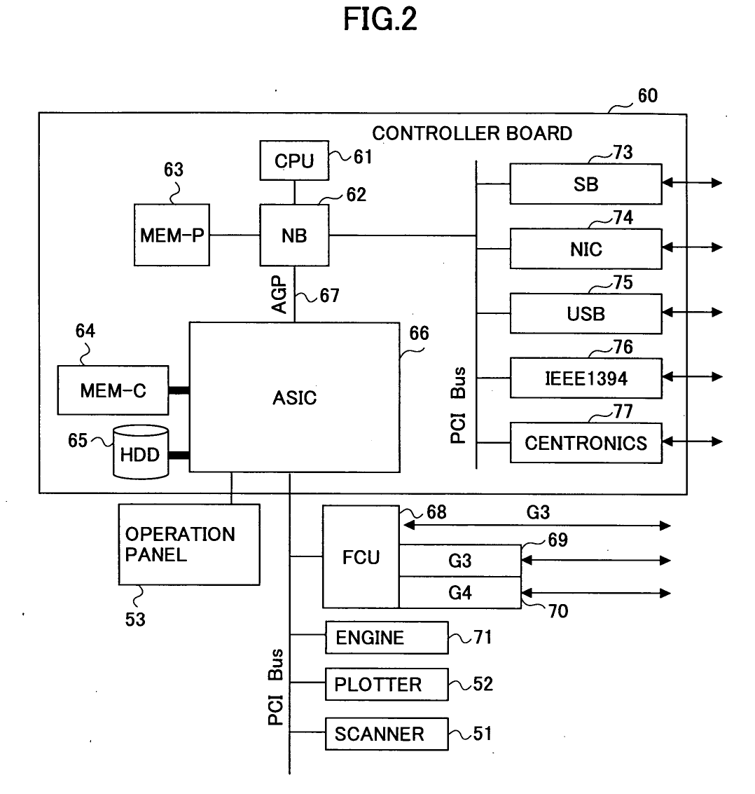

FIG. 2 is a block diagram showing a hardware construction of an embodiment of the multifunction peripheral 1. The multifunction peripheral 1 includes a controller board 60, an operation panel 53, a FCU 68, an engine 71, the scanner 51, and the plotter 52. The FCU 68 includes a G3-standard complying unit 69 and a G4-standard complying unit 70.

The controller board 60 includes a CPU 61, an ASIC 66, an HDD 65, a system memory (MEM-P) 63, a local memory (MEM-C) 64, a north bridge (NB) 62, a south bridge (SB) 73, a NIC 74 (Network Interface Card), a USB device 75, an IEEE1394 device 76, a Centronics device 77, and the MLB 54.

The operation panel 53 is connected to the ASIC 66 of the controller board 60. The SB 73, the NIC 74, the USB device 75, the IEEE1394 device 76, the Centronics device 77, and the MLB 54 are all connected to the NB 62 through the PCI bus. The MLB 54 is a printed circuit board connected to the image forming apparatus through the PCI bus. The MLB 54 converts image data supplied from the multifunction peripheral 1, and supplies the converted image data to the multifunction peripheral 1.

The FCU 68, the engine 71, the scanner 51, and the plotter 52 are connected to the ASIC 66 of the controller board 60 through the PCI bus.

In addition, the controller board 60 has the local memory 64 and the HDD 65 connected to the ASIC 66, and the CPU 61 and the ASIC 66 are connected through the NB 62 of a CPU chip set. Connecting the CPU 61 and the ASIC 66 together through the NB 62 in this manner makes it possible to cope with such a situation as the interface of the CPU 61 is not released to the public.

The ASIC 66 and the NB 62 are connected not through the PCI bus but through AGP (accelerated graphics port) 67. In this manner, the ASIC 66 and the NB 62 are connected through the AGP 67 instead of the low-speed PCI bus, thereby avoiding a drop of performance when controlling the execution of one or more processes which form the application layer 5 and the controller 6 of FIG. 1.

The CPU 61 is responsible for overall control of the multifunction peripheral 1. The CPU 61 starts and executes the NCS 30, the DCS 31, the OCS 32, the FCS 33, the ECS 34, the MCS 35, the OUS 36, the UCS 37, the SCS 38, the SRM 40, the FCUH 41, the MEU 45, and the IMH 42 as processes on the OS, and also starts and executes the printer application 20, the copy application 21, the fax application 22, and the scanner application 23, which make up the application layer 5.

The NB 62 is a bridge for connecting the CPU 61, the system memory 63, the SB 73, and the ASIC 66. The system memory 63 is used as a picture-rendering memory and the like of the multifunction peripheral 1. The SB 73 is a bridge for connecting the NB 62, the PCI bus, and peripheral devices. The local memory 64 is used as a copy-purpose image buffer and also as a code buffer.

The ASIC 66 is an image-processing-purpose IC that includes hardware elements for image processing. The HDD 65 is a storage for storing images, document data, programs, font data, forms, etc. The operation panel 53 serving as an operating unit and a display unit is operated by a user to receive input data from the user, and provides display presentation to the user.

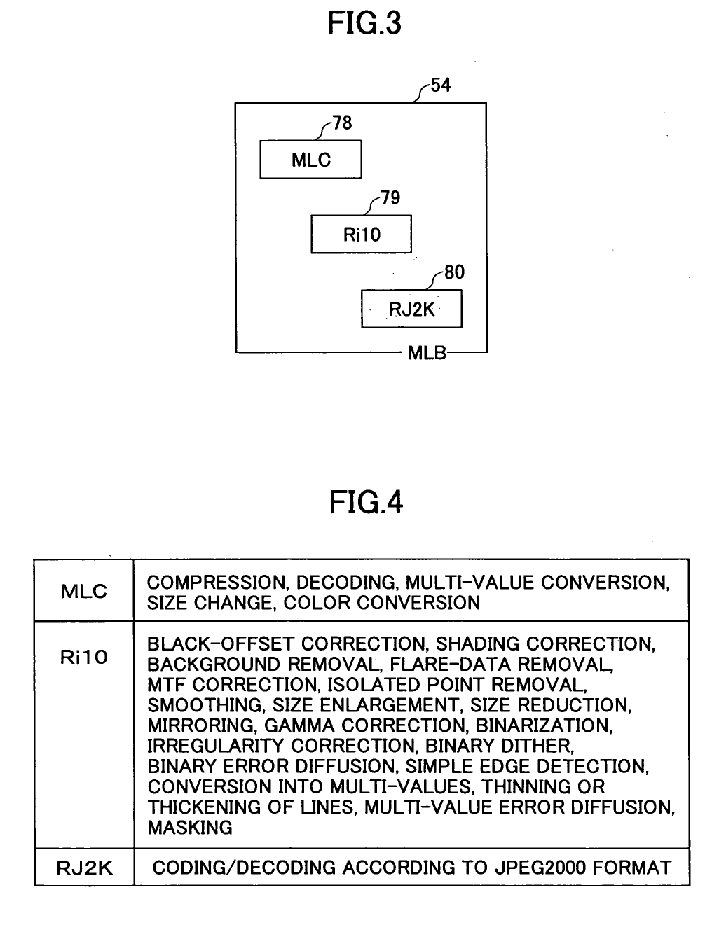

FIG. 3 is an illustrative drawing showing the construction of the MLB 54. The MLB 54 includes an MLC 78, a Ri10 79 (hereinafter referred to simply as Ri 79 in order to avoid confusion with reference numerals), and a RJ2K 80. The MLC 78, the Ri 79, and the RJ2K 80 are chips having conversion functions. The MLC 78 is a chip that is indigenous to the MLB 54, and the Ri79 and the RJ2K 80 are chips that are optionally provided. The MLC 78 serves as a control unit, and the Ri 79 and the RJ2K 80 serve as conversion units. The MLC 78 may also attend to conversion of image data.

FIG. 4 is a diagram for explaining the conversion function of the MLC 78, the Ri 79, and the RJ2K 80. The MLC 78 is a chip provided with a compression function, a decompression function, a multi-value conversion function, a size change function, and a color conversion function. The Ri 79 is a chip provided with various functions such as black-offset correction, shading correction, background removal, flare data removal, MTF correction, isolated point removal, smoothing, size enlargement, size reduction, mirroring, gamma correction, binarization, irregularity correction, binary dither, binary error diffusion, simple edge detection, conversion into multi-values, thinning or thickening of lines, multi-value error diffusion, masking, etc. The RJ2K 80 is a chip that performs coding/decoding according to the JPEG2000 format. Here, the term “image data conversion” refers to various conversions as shown in FIG. 4.

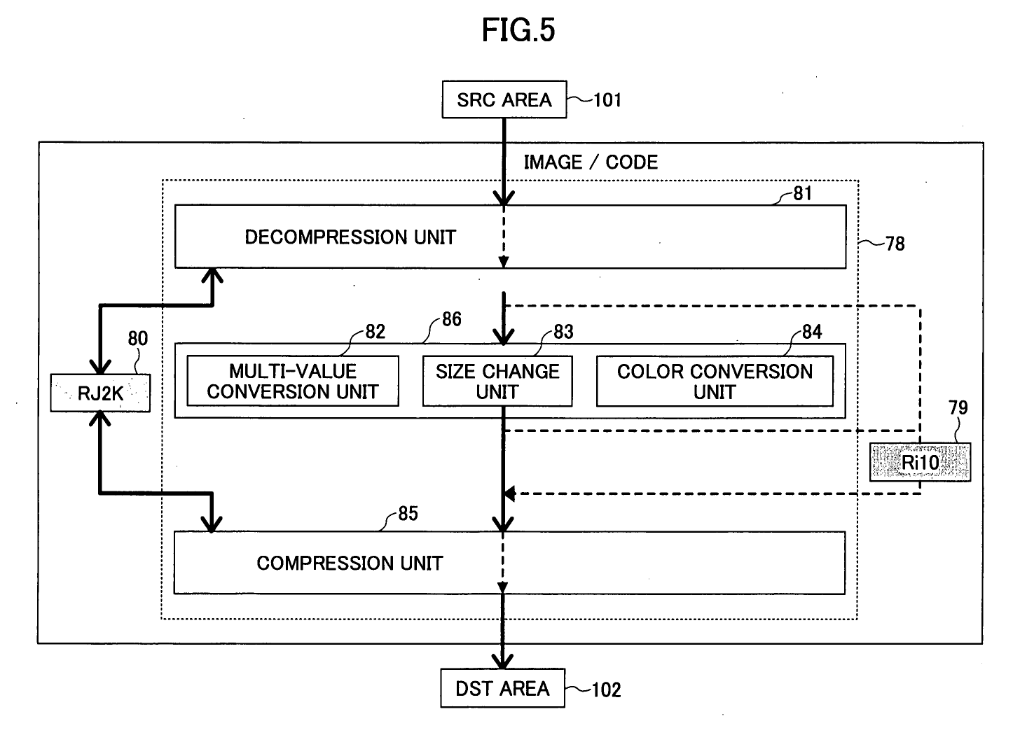

FIG. 5 is a diagram for explaining the flow of image data when the image data is converted by the MLB 54. In the following, the transfer of image data is sometimes referred to as the inputting or outputting of image data. Further, the conversion of image data is sometimes referred to as compression, decompression, coding, and decoding,

A description will first be given of the internal configuration of the MLC 78. The MLC 78 includes a decompression unit 81, a multi-value conversion unit 82 for performing multi-value conversion, a size change unit 83 for changing the size of an image, a color conversion unit 84 for changing the color of an image, and a compression unit 85. The decompression unit 81 decompresses image data that has been compressed. The compression unit 85 compresses image data. The decompression unit 81 and the compression unit 85 conform to the JPEG, MH/MR/MMR, NFC1 formats. In the following, the multi-value conversion unit 82, the size change unit 83, and the color conversion unit 84 are collectively referred to as a conversion unit 86 for the sake of simplicity.

The Ri 79 converts image data supplied from the decompression unit 81, and also converts image data supplied from the conversion unit 86.

The RJ2K 80 performs coding/decoding of image data according to the JPEG2000 format as the image data is supplied from the decompression unit 81 or from the compression unit 85.

An SRC area 101 is a memory area that stores image data to be converted. A DST area 102 is a memory area that stores the converted image data. These memory areas are allocated by the IMH 42 in the system memory 63.

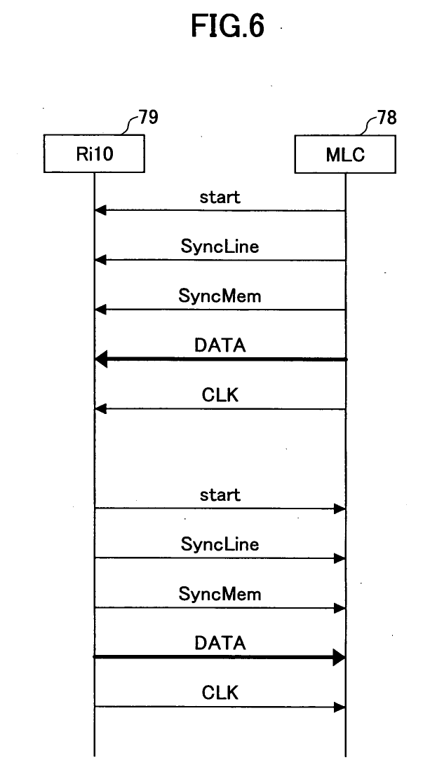

FIG. 6 is a sequence chart showing signals exchanged between the MLC 78 and the Ri 79. Those signals include five types, i.e., “start”, “SyncLine”, “SyncMem”, “DATA”, and “CLK”, and are exchanged in two ways.

The “start” signal indicates a start of transmission of image data, and triggers the starting of transfer of line data when image data is output. The signal “SyncLine” specifies a sub-scan portion in the transferred image data, and, particularly, indicates a sub-scan valid period that signifies that the image data being output is sub-scan data. The signal “SyncMem” specifies a main-scan portion in the transferred image data, and, particularly, indicates a main-scan valid period that signifies that the image data being output is main-scan data.

The signal “DATA”, serving as an image-data transfer unit, corresponds to an image data outputting terminal which provides data from the MLC 78 to the Ri 79, or corresponds to an image data inputting terminal which provides data from the Ri 79 to the MLC 78. In this manner, the transfer of image data is performed inside the MLB 54, so that the image data is transferred at a constant rate.

The signal “CLK”, serving as a clock unit, is a synchronizing clock that is used to output the image data from the MLC 78 to the Ri 79, or is a synchronizing clock that is used to input the image data from the Ri 79 to the MLC 78.

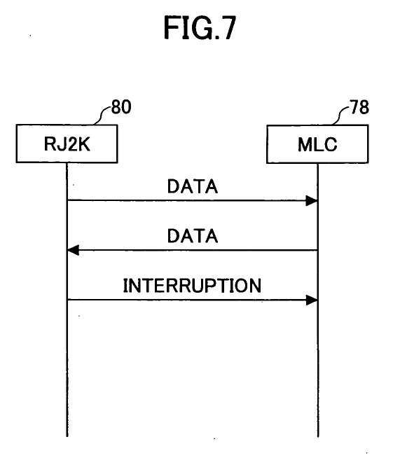

FIG. 7 is a sequence chart showing the exchange of signals between the MLC 78 an the RJ2K 80. The signals exchanged between the MLC 78 and the RJ2K 80 include interruption signals from the RJ2K 80 to MLC 78 in addition to image data signals.

A description will be given of the interruption signals. Causes of the generation of an interruption signal at the time of coding include a completion of outputting of image data that is equal in amount to a predetermined coding unit size, a completion of outputting of image data that is equal in amount to one page of a print sheet, and an occurrence of error at the time of coding.

Causes of the generation of an interruption signal at the time of decoding includes a completion of outputting of image data that is equal in amount to the number of lines equivalent to one unit of processing, a completion of outputting of image data that is equal in amount to one page of a paper sheet, and an occurrence of error at the time of decoding.

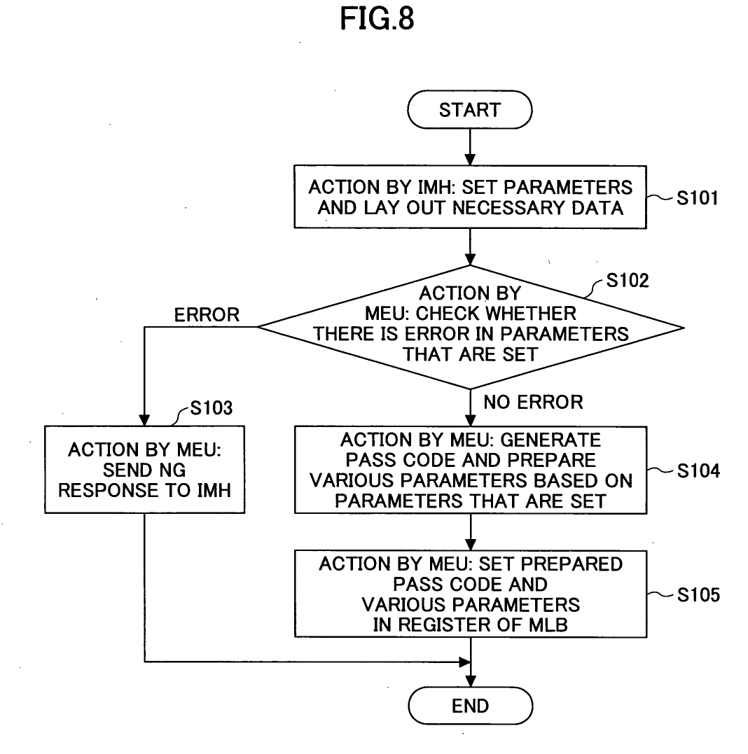

The MLB 54 as described above is controlled by the MEU 45. The MEU 45 converts image data by use of the MLB 54 in response to a request from the IMH 42. FIG. 8 is a flowchart showing a procedure performed by the IMH 42 and the MEU 44.

At step S101, the IMH 42 sets parameters, and lays out necessary data. The setting of parameters achieves the provision of parameters for conversion of JPEG into JPEG2000, for example. The necessary data includes data of a color conversion table that is used when RGB is converted into sRGB.

At step S102, the MEU 45 checks whether there is an error in the parameters set by the IMH 42. Such error occurs when a format is set that is impossible for the MLB 54 to convert. If there is an error, the MEU 45 sends an NG response to the IMH 42 at step S103, resulting in the procedure coming to an end.

If there is no error, at step S104, the MEU 45 attends to the generation of a pass code and the preparation of various parameters based on the parameters that have been set. At step S105, the MEU 45 sets the prepared pass code and various parameters in registers of the MLB 54. With this, the procedure comes to an end.

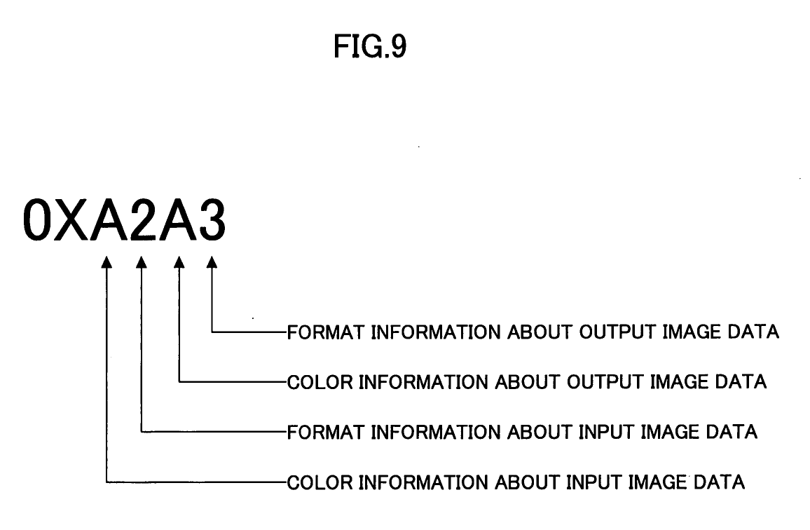

FIG. 9 is an illustrative drawing for explaining the pass code. In FIG. 9, the pass code, serving as conversion indicating information, is shown as two-byte data represented in the hexadecimal form. The upper-order byte of this pass code is regarding input image data, and the lower-order type is regarding output image data.

The four upper-order bits of the upper-order byte specify color information about the input image data, and the four lower-order bits specify format information about the input image data. The four upper-order bits of the lower-order byte specify color information about the output image data, and the four lower-order bits specify format information about the output image data. In this manner, the pass code includes format information about image data prior to conversion and the image data that is converted.

Based on the pass code, the MLC 78 chooses a chip from the Ri 79 and the RJ2K 80 for image-data conversion. As a result, various conversions of image data can automatically be performed only by the MLB 54. With this provision, the MEU 45 simply stores the pass code in the register, and thereby easily obtains image data that has undergone desired conversion.

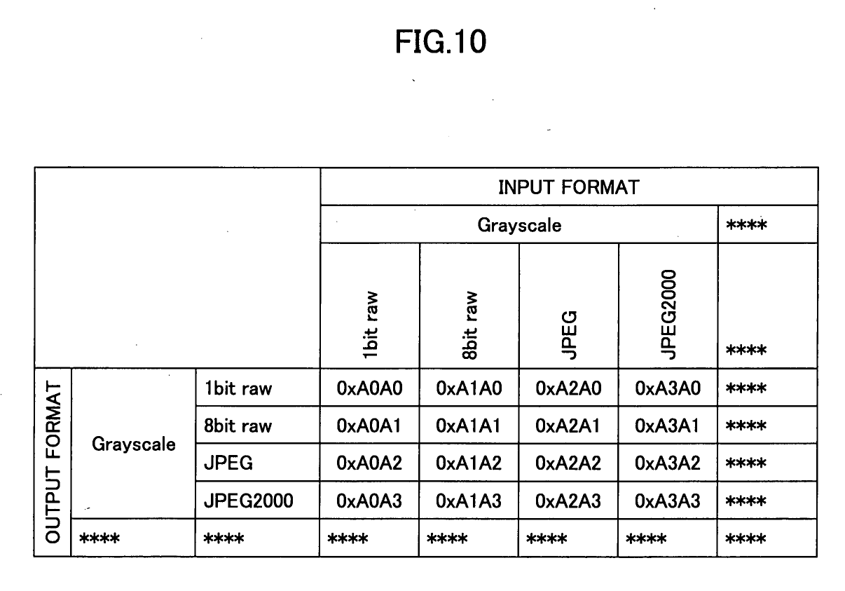

There are many pass codes, depending on the types of image data. Such pass codes may be stored in an array format as shown in FIG. 10. FIG. 10 is a table chart showing only a portion relating to the grayscale among various image types.

Items arranged in a row of the table of

FIG. 10 indicate input formats, which are the formats of image data prior to conversion. Items arranged in a column of the table indicate converted formats. The input formats include a 1-bit raw, an 8-bit raw, JPEG, and JPEG2000, with regard to the grayscale. By the same token, the output formats include a 1-bit raw, an 8-bit raw, JPEG, and JPEG2000, with regard to the grayscale.

The pass code for conversion from the 8-bit raw to the JPEG, for example, is 0xA1A2. As a further example, the pass code for conversion from the 1-bit raw to the JPEG2000 is 0xA0A3.

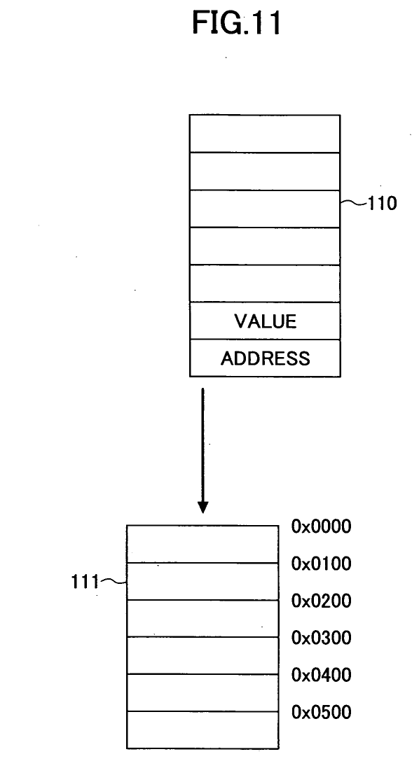

FIG. 11 is an illustrative drawing for explaining the registers of the MLB 54. In FIG. 11, registers 110 belong to the MLB 54, and registers 111 belong to the Ri 79 or the RJ2K 80.

As previously described, the registers of the MLB 54 include an area in which a pass code and addresses indicated by the MEU 45 are stored. The MLC 78 writes the values stored in this area into the register 111 of the Ri 79 or the RJ2K 80 through address conversion.

In this manner, the MLC 78 stores the pass code indicated by the MEU 45 in the registers of the Ri 79 or the RJ2K 80. As a result, the Ri 79 or the RJ2K 80 can attend to processing according to the pass code.

In the following, a description will be given of how image data is converted during actual processing.

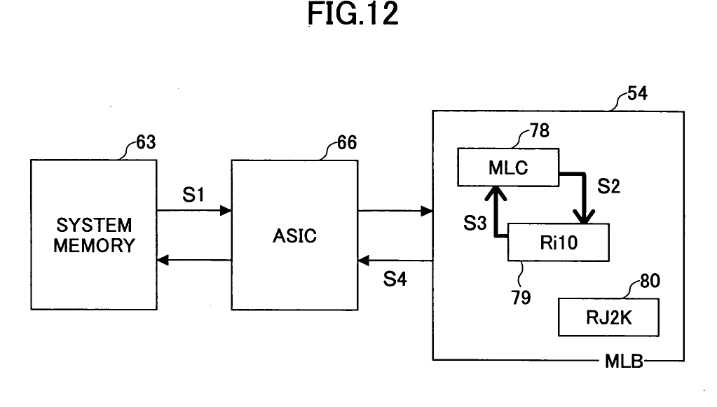

FIG. 12 is an illustrative drawing for explaining a case in which the Ri 79 performs conversion. FIG. 12 shows the flow of image data by reference numerals where the flow of image data occurs between the system memory 63, the ASIC 66, and the MLB 54. The image data travels as S1, S2, S3, and S4 in the order named.

Image data is output from the system memory 63 to the MLB 54 through the ASIC 66. Then, the image data is transferred from the MLC 78 to the Ri 79. The image-data converted by the Ri 79 is output to the MLC 78, followed by storage in the system memory 63 through the ASIC 66.

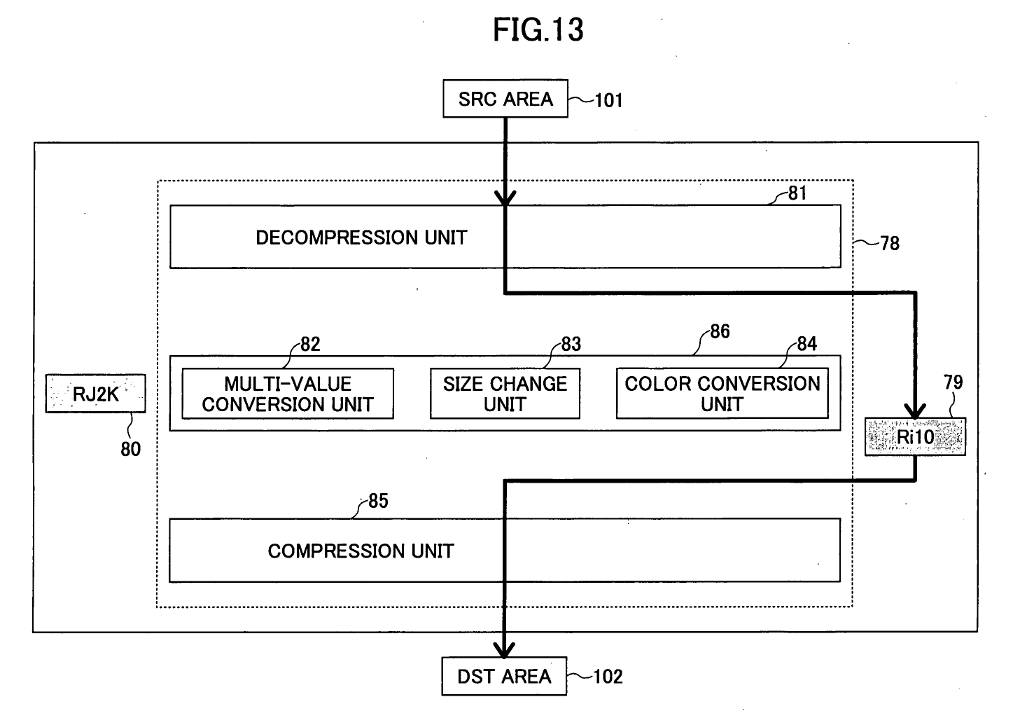

FIG. 13 is an illustrative drawing that shows the flow of image data of the process of FIG. 12 inside the MLB 54 shown in FIG. 5.

The image data is supplied from the SRC area 101 to the Ri 79 through the decompression unit 81, and is converted by the Ri 79. The converted data is stored in the DST area 102 through the compression unit 85. Here, the decompression unit 81 and the compression unit 85 only provide passages, and do not perform decompression/compression.

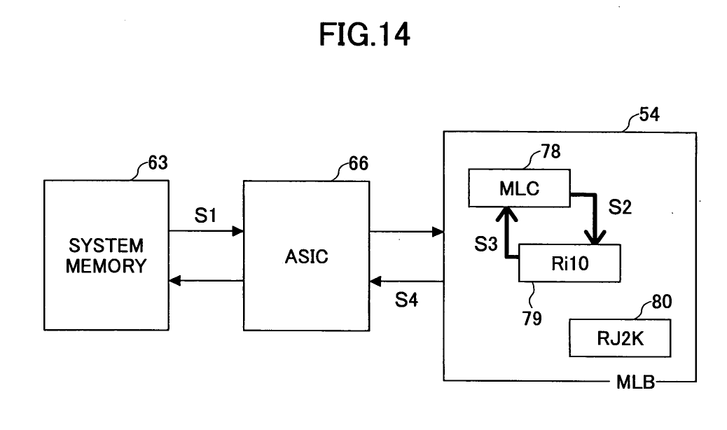

FIG. 14 is an illustrative drawing showing a case in which the MLC 78 as well as the Ri 79 attends to conversion. FIG. 14 shows the flow of image data by reference numerals where the flow of image data occurs between the system memory 63, the ASIC 66, and the MLB 54. The image data travels as S1, S2, S3, and S4 in the order named.

FIG. 14 appears the same as FIG. 12 on the surface. It should be noted, however, that S2 is different. In S2, image data converted by the MLC 78 is output to the Ri 79. The rest of the procedure is the same as FIG. 12.

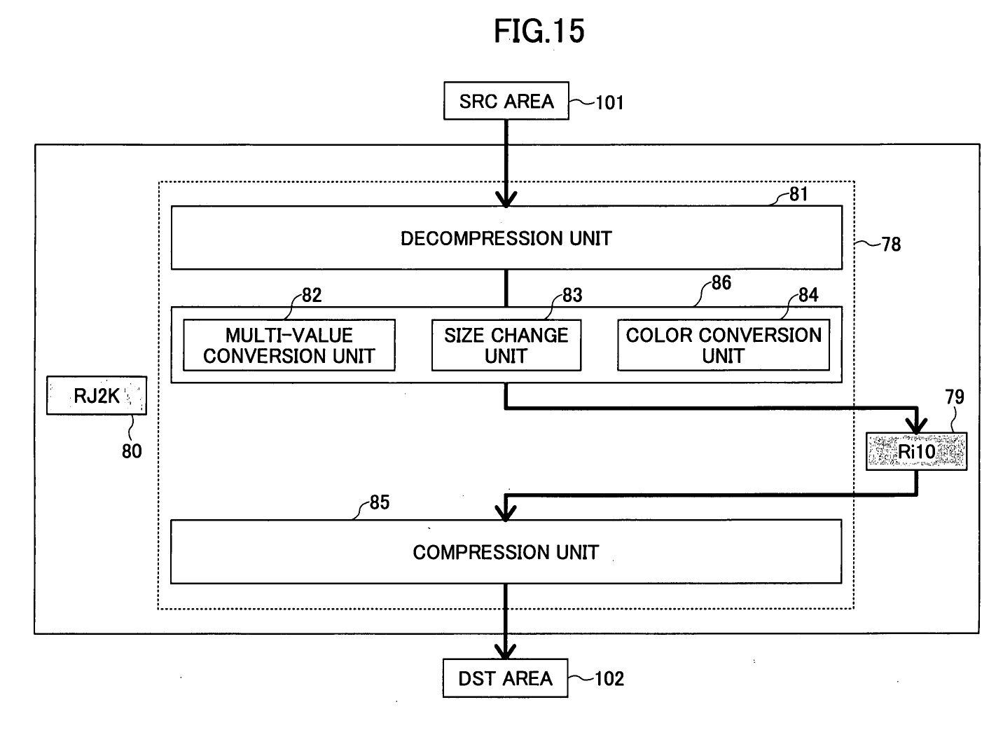

FIG. 15 is an illustrative drawing showing the flow of image data of the process of FIG. 14 inside the MLB 54.

The decompression unit 81 decompresses image data supplied from the SRC area 101. The image data is then converted by the conversion unit 86, and is further converted by the Ri 79. The compression unit 85 then compresses the image data for storage in the DST area 102. In this manner, the decompression unit 81 and the compression unit 85 perform respective decompression and compression during the process shown in FIG. 15, and the conversion unit 86 further attends to conversion.

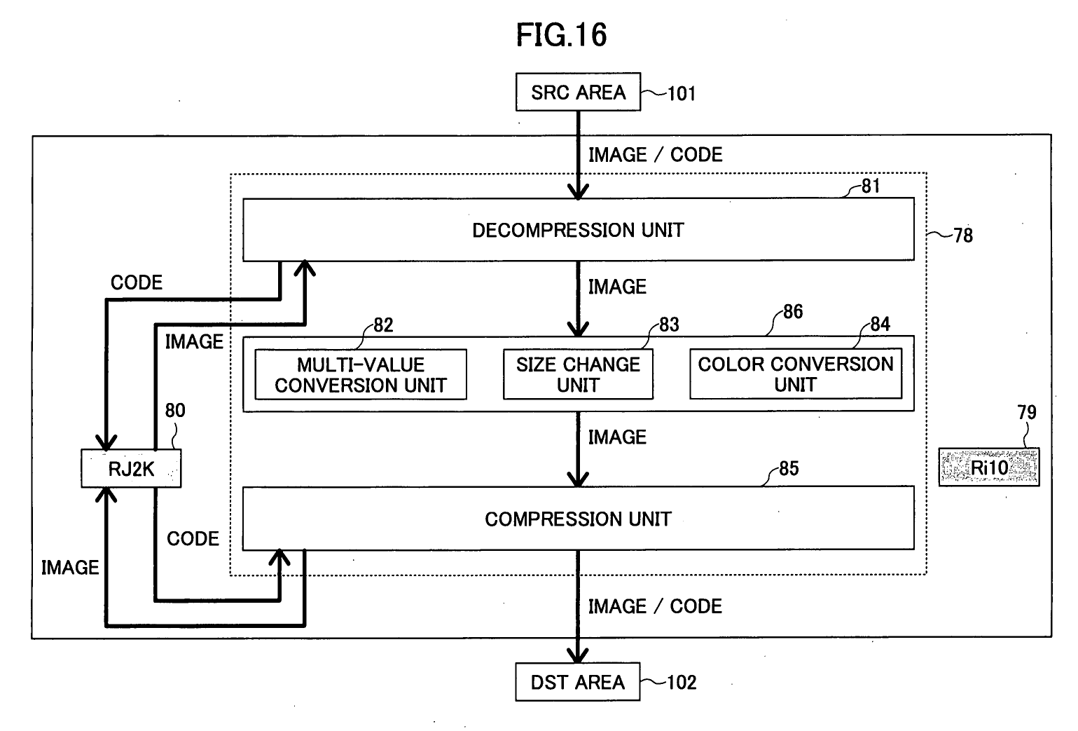

In the following, a process will be described in which the RJ2K 80 performs conversion in addition to the MLC 78 and the Ri 79. FIG. 16 is an illustrative drawing for explaining a process by which the RJ2K 80 attends to conversion. FIG. 16 shows the flow of image data, and also illustrates whether image data is coded or not. In FIG. 16, coded image data is designated simply as “CODE”, and image data that is not coded is designated simply as “IMAGE”.

The image data that is supplied from the SRC area 101 to the decompression unit 81 may be either an image or codes. If the image data is already coded, the conversion of the image data requires decoding first. The decompression unit 81 thus provides the coded image data to the RJ2K 80. The RJ2K 80 decodes the image data, and returns the decoded image data to the decompression unit 81.

As a result, image data exchanged between the decompression unit 81, the conversion unit 86, and the compression unit 85 is image data that is not coded.

When there is need to encode the image data supplied to the compression unit 85, the image data is supplied from the compression unit 85 to the RJ2K 80. The RJ2K 80 attends to the coding of the image data, and the coded image data is returned to the compression unit 85. The compression unit 85 stores the coded image data in the DST area 102.

In this manner, unlike the Ri 79, the RJ2K 30 performs coding/decoding of image data supplied from the decompression unit 81 or from the compression unit 85.

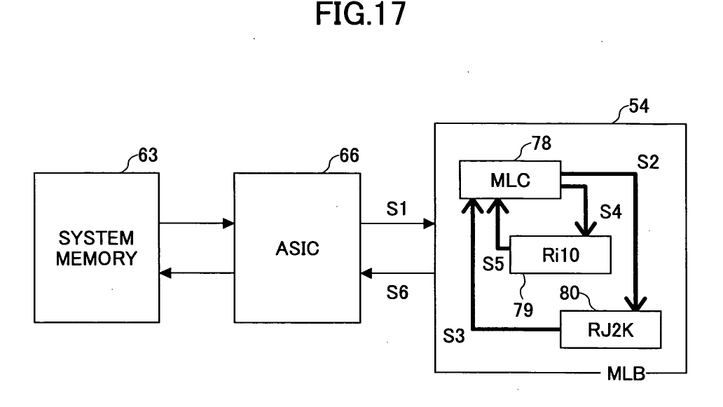

FIG. 17 is an illustrative drawing showing a case in which conversion is performed by the RJ2K 80 in addition to the Ri 79 and the MLC 78.

Similar to the previous drawings, FIG. 17 shows the flow of image data by reference numerals where the flow of image data occurs between the system memory 63, the ASIC 66, and the MLB 54. The image data travels as S1, S2, S3, S4, S5, and S6 in the order named.

Image data is output from the system memory 63 to the MLB 54 through the ASIC 66. The image data is then transferred from the MLC 78 to the RJ2K 80. Image data decoded by the RJ2K 80 is returned to the MLC 78. The image data supplied to the MLC 78 is converted by the MLC 78, and is then supplied to the Ri 79. The image data is further converted by the Ri 79, and is then output to the MLC 78. Finally, the image data supplied from the MLB 54 is stored in the system memory 63 through the ASIC 66.

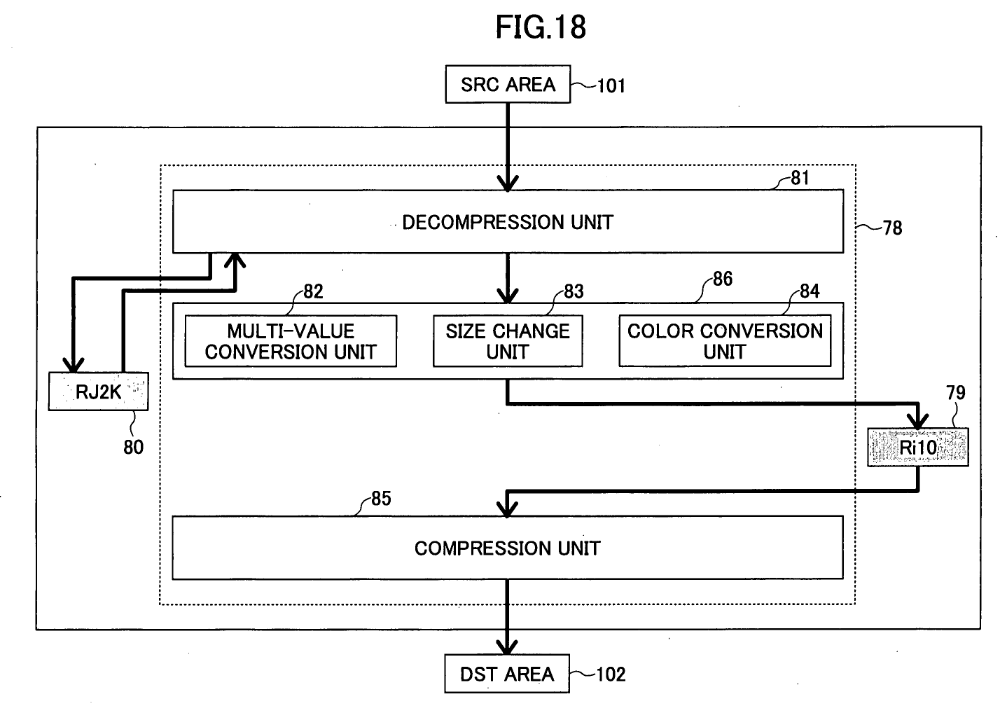

FIG. 18 is an illustrative drawing for explaining the flow of image data of the process of FIG. 17 inside the MLB 54.

The RJ2K 80 decodes image data as the image data is supplied from the SRC area 101 through the decompression unit 81. The image data decoded by the RJ2K 80 is returned to the decompression unit 81. The decompression unit 81 supplies the image data to the conversion unit 86, which performs conversion prior to provision to the Ri 79. The image data provided to the Ri 79 is converted by the Ri 79, and is then stored in the DST area 102 through the compression unit 85.

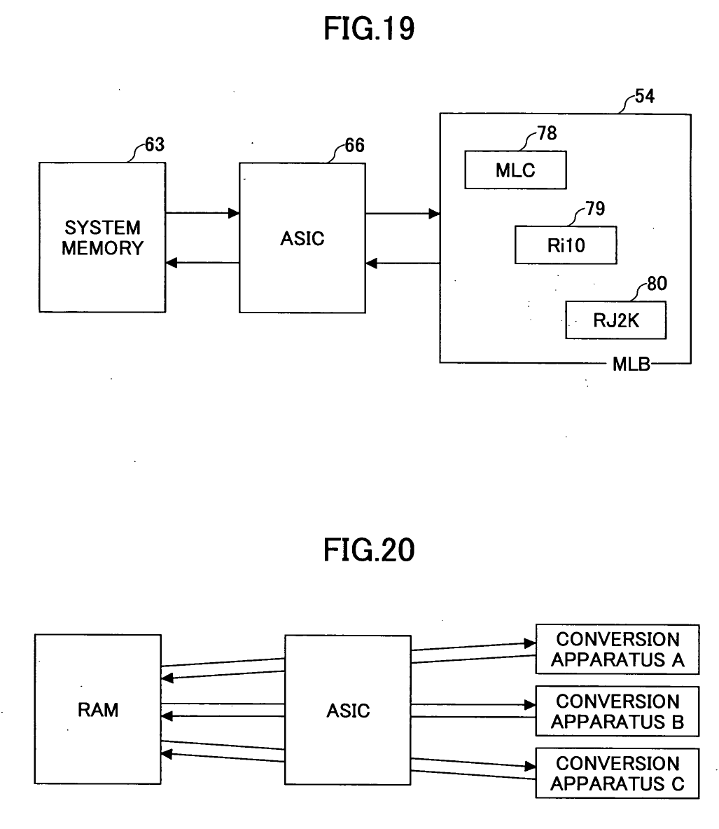

In the description that has been provided heretofore with respect to the conversion of image data, different conversions may be combined together in some cases. With respect to all types of conversions including such combined conversions, it should be noted that, as shown in FIG. 19, the image data travels only once on the way to the MLB 54 and on the way back to the system memory 63, regardless of the combinations of conversions.

This makes it possible to reduce the exclusive use of a shared bus to a minimum when the shared bus is used by other apparatuses.

Further, the present invention is not limited to these embodiments, but various variations and modifications may be made without departing from the scope of the present invention.

The present application is based on Japanese priority application No. 2004-42783 filed on Feb. 19, 2004, with the Japanese Patent Office, the entire contents of which are hereby incorporated by reference.

What is claimed is:

1. An electronic device which receives image data, and converts the image data for outputting therefrom, comprising:
a plurality of conversion units configured to convert the image data;
a control unit configured to control said conversion units;
an image data transfer unit configured to transfer the image data between said control unit and at least one of said conversion units; and
a clock unit configured to provide synchronization between said control unit and at least one of said conversion units for transfer of the image data.

2. The electronic device as claimed in claim 1, wherein said control unit supplies to one of said conversion units a signal indicative of a start of transfer of the image data when transferring the image data to the one of said conversion units.

3. The electronic apparatus as claimed in claim 1, wherein said control unit supplies to one of said conversion units a signal indicating that the image data being transferred is a sub-scan portion when the sub-scan portion of the image data is being transferred to the one of said conversion units.

4. The electronic apparatus as claimed in claim 1, wherein said control unit supplies to one of said conversion units a signal indicating that the image data being transferred is a main-scan portion when the main-scan portion of the image data is being transferred to the one of said conversion units.

5. The electronic device as claimed in claim 1, wherein one of said conversion units supplies to said control unit a signal indicative of a start of transfer of the converted image data when transferring the converted image data to said control unit.

6. The electronic apparatus as claimed in claim 1, wherein one of said conversion units supplies to said control unit a signal indicating that the image data being transferred is a sub-scan portion when the sub-scan portion of the converted image data is being transferred to said control unit.

7. The electronic apparatus as claimed in claim 1, wherein one of said conversion units supplies to said control unit a signal indicating that the image data being transferred is a main-scan portion when the main-scan portion of the converted image data is being transferred to said control unit.

8. The electronic device as claimed in claim 1, wherein at least one of said conversion units further includes an interruption unit configured to output an interruption signal to said control unit.

9. The electronic device as claimed in claim 8, wherein said interruption unit outputs the interruption signal in response to a completion of conversion of image data that is equal to a predetermined amount.

10. The electronic device as claimed in claim 8, wherein said interruption unit outputs the interruption signal in response to a completion of conversion of image data that is equal in amount to one page of a print sheet.

11. The electronic device as claimed in claim 8, wherein said interruption unit outputs the interruption signal in response to an error occurring during the conversion of the image data.

12. The electronic device as claimed in claim 1, wherein said control unit makes one of said conversion units convert the image data according to a request indicative of specifics of conversion that is applied to the image data.

13. The electronic device as claimed in claim 12, wherein said control unit selects one of said conversion units according to the request so as to make the selected one of said conversion units convert the image data.

14. The electronic device as claimed in claim 12, wherein the request specifies a format of the image data prior to conversion and a format of the converted image data.

15. The electronic device as claimed in claim 1, wherein the image data is transferred at a constant rate between said control unit and at least one of said conversion units.

16. The electronic device as claimed in claim 1, wherein each of said conversion units is a chip.

17. The electronic device as claimed in claim 1, implemented on a printed circuit board that is connectable to an upper-order apparatus.

18. The electronic device as claimed in claim 17, wherein the image data is received from the upper-order apparatus, and the converted image data is output to the upper-order apparatus.

19. The electronic device as claimed in claim 1, wherein said control unit is also configured to convert the image data.

20. An image forming apparatus, comprising:
hardware resources configured to form images;
a memory having a program stored therein for causing said hardware resources to form the images; and
an electronic device configured to receive image data and convert the image data for outputting therefrom, said electronic device including:
a plurality of conversion units configured to convert the image data;
a control unit configured to control said conversion units;
an image data transfer unit configured to transfer the image data between said control unit and at least one of said conversion units; and
a clock unit configured to provide synchronization between said control unit and at least one of said conversion units for transfer of the image data.

21. The image forming apparatus as claimed in claim 20, further comprising a conversion request generating unit which generates a conversion request, wherein said electronic device converts the image data in response to the conversion request.

22. The image forming apparatus as claimed in claim 21, further comprising a conversion-type specifying unit which generates information about a format of the image data prior to conversion and a format of the image data after the conversion, said information being supplied to said conversion request generating unit.

23. The image forming apparatus as claimed in claim 22, wherein said conversion request generating unit generates the conversion request responsive to the information supplied from said conversion-type specifying unit.

24. The image forming apparatus as claimed in claim 20, further comprising a memory-area allocating unit which allocates a memory area in which the image data to be converted by said electronic device and the converted image data are stored.

25. A method of converting image data by use of a plurality of conversion units configured to convert the image data and a control unit configured to control the conversion units, comprising the steps of:
notifying the control unit of a type of conversion that is to be performed with respect to the image data;
selecting, by the control unit, one of the conversion units in response to the notified-type of conversion;
supplying, from the control unit to the selected one of the conversion units, a clock signal that provides synchronization for transfer of the image data;
supplying, from the control unit to the selected one of the conversion units, a signal indicative of a start of transfer of the image data; and
transferring the image data from the control unit to the selected one of the conversion units.

26. The method as claimed in claim 25, further comprising the steps of:
transmitting, from the selected one of the conversion units to the control unit, a clock signal that provides synchronization for transfer of converted image data; and
transferring the converted image data from the selected one of the conversion units to the control unit.

27. A method of converting image data by use of a plurality of conversion units configured to convert the image data, a control unit configured to control the conversion units, and a conversion request generating unit configured to request conversion, comprising the steps of:
generating, by the conversion request generating unit, information about the type of conversion that is to be performed with respect to the image data;
instructing, by the conversion request generating unit, the control unit to perform the conversion based on the information;
selecting, by the control unit, one of the conversion units in response to the notified type of conversion;
supplying, from the control unit to the selected one of the conversion units, a clock signal that provides synchronization for transfer of the image data;
supplying, from the control unit to the selected one of the conversion units, a signal indicative of a start of transfer of the image data; and
transferring the image data from the control unit to the selected one of the conversion units.

28. The method as claimed in claim 27, further comprising a step of notifying, by the control unit, the conversion request generating unit of a completion of the conversion of the image data.
